(19) United States
(12) Patent Application Publication
(10) Pub. No.: US 2019/0294474 A1
(43) Pub. Date: Sep. 26, 2019

(54) PREDICTIVE QUEUE MAP FOR PARALLEL COMPUTING RESOURCE MANAGEMENT

(71) Applicant: CA, Inc., New York, NY (US)

(72) Inventor: Mukul Jain, San Jose, CA (US)

(21) Appl. No.: 15/936,390

(22) Filed: Mar. 26, 2018

(51) Int. Cl. G06F 9/50

(52) U.S. Cl. CPC G06F 9/5038; G06F 2209/5019; G06F 9/5077

(57) ABSTRACT

Techniques are disclosed relating to implementation and predictions for a queue map that specifies amounts of execution resources assigned to queues of applications managed by a resource negotiator module. In some embodiments, an apparatus is configured to generate a queue map. In some embodiments, the apparatus is configured to simulate predicted modifications to the queue map based on input of one or more applications to one or more queues. In some embodiments, the apparatus is configured to display the predicted modifications. In some embodiments, the apparatus is configured to modify a queue map based on the approval of the predicted modifications. In some embodiments, the disclosed prediction techniques may improve overall performance and efficiency of a multi-queue system and/or facilitate informed selection of queues for new applications.

### BACKGROUND

### Technical Field

This disclosure relates generally to parallel computer processing and more particularly to dynamically adjusting execution resources assigned to application queues based on new applications.

### Description of the Related Art

Assignment of execution resources to tasks is typically handled by resource managers or resource negotiators. Clusters are one example of the granularity at which execution resources are assigned to perform tasks in parallel. Examples of resource negotiators used for cluster management include, without limitation: YARN (Yet Another Resource Negotiator), MapReduce, Hive, Pig, etc. YARN, for example, uses cluster manager agents or node manager agents to monitor the processing operations of individual clusters. These cluster manager agents communicate their gathered information to the resource negotiator. The resource negotiator typically handles queues that store applications to be dispatched for execution using execution resources. Traditionally, a queue is assigned a portion (e.g., a fraction or percentage) of available execution resources.

### SUMMARY

Techniques are disclosed relating to the management of execution resources for performing tasks in parallel. In some embodiments, a resource negotiator module maintains a queue map that specifies amounts of execution resources assigned to different queues at different times. Each queue may track one or more applications to be dispatched for execution using the execution resources assigned to the queue. In some embodiments, the resource negotiator module receives information indicating one or more proposed applications to be added to one or more queues. In some embodiments, information for the proposed applications may include details concerning when applications will run, estimated execution resources needed by the applications, how quickly the application should be completed, priority, etc.

In some embodiments, the resource negotiator module predicts updates to the queue map based on the proposed addition of the application(s). For example, in some embodiments, the resource negotiator module is configured to simulate the addition of one or more applications to the queue. In some embodiments, the resource negotiator module causes a prediction of modifications to the queue map to be displayed for approval or rejection.

### BRIEF DESCRIPTION OF THE DRAWINGS

FIG. 1 is a diagram illustrating an exemplary resource negotiator module, according to some embodiments.

FIG. 2 is a block diagram illustrating exemplary execution resources, according to some embodiments.

FIG. 3 is a diagram illustrating exemplary use of a queue map to assign execution resources to queues, according to some embodiments.

FIG. 4 is a plot of an exemplary history of queue execution with a static amount of execution resources assigned to each queue, according to some embodiments.

FIG. 5 is a plot illustrating information indicated by an exemplary queue map, according to some embodiments.

FIG. 6 is a plot block graph illustrating an exemplary queue map prediction according to some embodiments.

FIG. 7 is a flow diagram illustrating an exemplary method for queue map prediction, according to some embodiments.

FIG. 8 is a block diagram illustrating an exemplary computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “resource negotiator module configured to generate a predicted modification to a queue map” is intended to cover, for example, a module that performs this function during operation, even if the corresponding device is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

### Overview of Queue Map Prediction

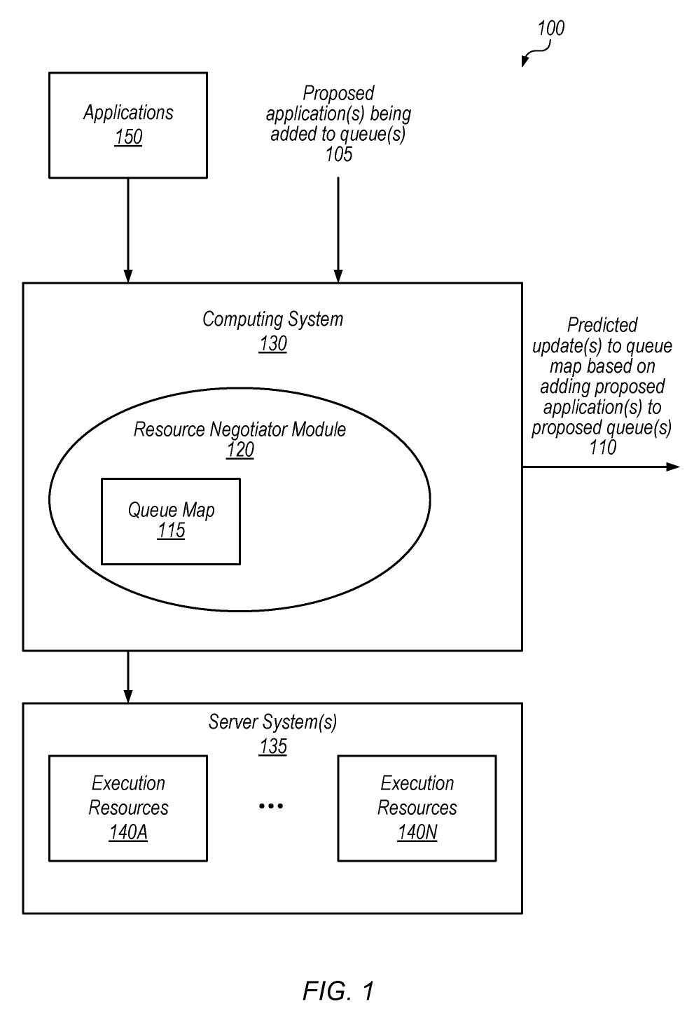

FIG. 1 is a block diagram illustrating an exemplary system with a resource negotiator module configured to output predicted updates to a queue map, according to some embodiments. In the illustrated embodiment, system 100 includes a computing system 130 and one or more server systems 135. In the illustrated embodiment, computing system 130 includes a resource negotiator module 120 which maintains a queue map 115 for assigning execution resources 140 of server system 135 to applications 150.

Resource negotiator module 120, in some embodiments, is configured to manage multiple queues for applications 150. In some embodiments, each queue is assigned a set of execution resources 140 and resource negotiator module 120 provides the queues with access to those resources. Thus, in the illustrated embodiment, resource negotiator module 120 is configured to dispatch applications 150 for execution using execution resources 140A-140N of one or more server systems 135.

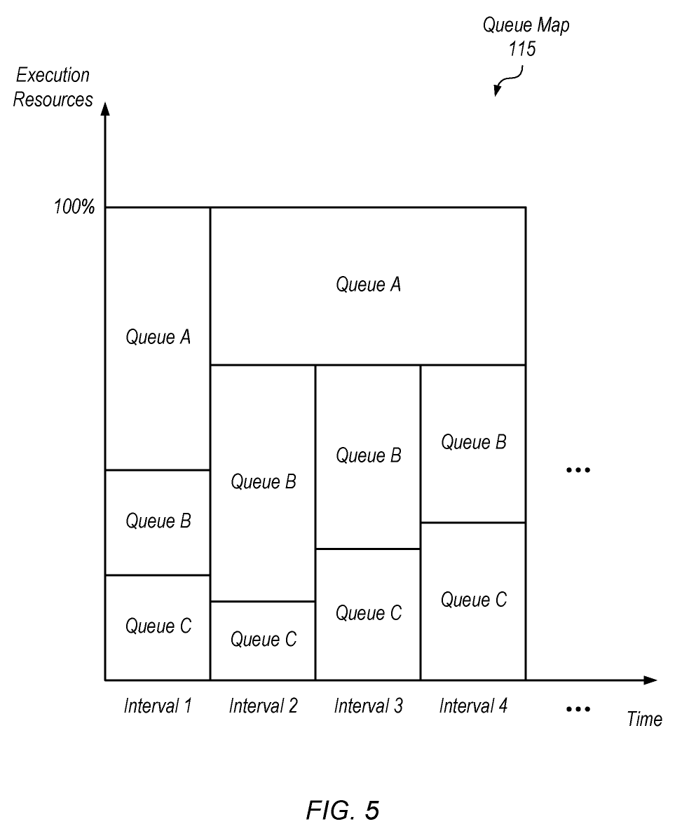

In some embodiments, resource negotiator module 120 is configured to generate and/or maintain a queue map 115 which indicates amounts of execution resources 140 assigned to different queues at different times. FIG. 5, discussed in further detail below, shows a plot of execution resources over time for an example queue map.

In the illustrated embodiment, resource negotiator module 120 receives information 105 indicating one or more proposed applications 140 to be added to one or more queues. Information 105 may include the following details, for example: when the application will run, an amount of execution resources 140 the application 150 will need, and/or priority of the application (e.g., how quickly the application should be completed, priority relative to other applications, etc.).

In some embodiments, resource negotiator module 120 is configured to simulate the addition of one or more applications 150 to the queue map 115 to predict how resource negotiator module 120 would modify the queue map based on the addition of one or more applications. In the illustrated embodiment, resource negotiator module 120 is configured to output information 110 that indicates one or more predicated updates to the queue map 115 based on the addition of the proposed applications.

In some embodiments, the queue map predictions may allow a user or module sending the proposed applications 150 to determine whether to actually add the applications to the indicated queue. For example, in some embodiments, the approval or rejection of the proposed applications 150 comes directly from a user. In some embodiments, the approval or rejection may be generated automatically from some other module.

For example, resource negotiator module 120 may receive input approving or rejecting the proposed applications 150. In various embodiments, this may advantageously allow the resource negotiator module 120 to efficiently assign execution resources for the first invocation of the proposed applications (if the applications are added) and/or inform one or more other modules of predicted effects of adding applications.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

### Exemplary Execution Resources

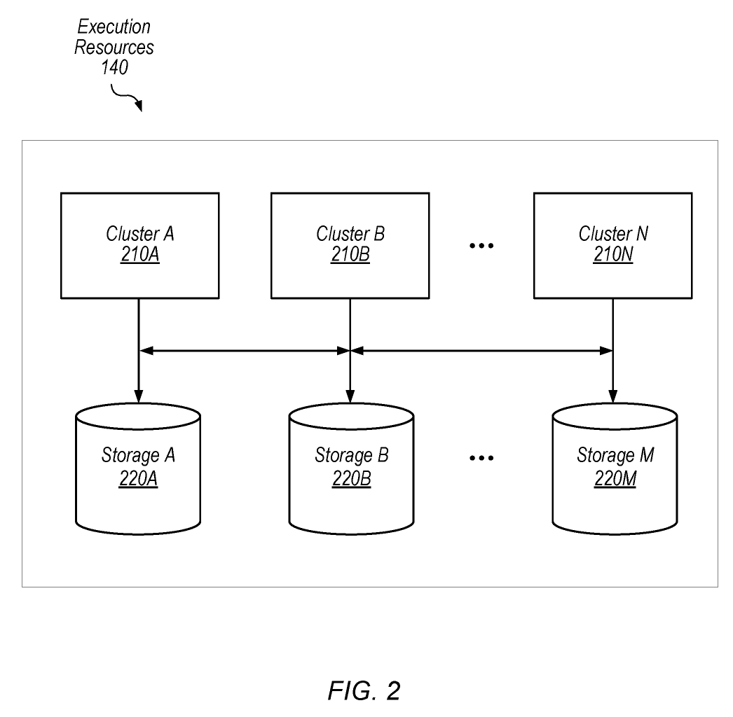

FIG. 2 is a block diagram illustrating exemplary execution resources configured to execute tasks, according to some embodiments. In the illustrated embodiment, execution resources 140 include clusters 210A-210N, which share storage elements 220A-220N.

In the illustrated embodiment, execution resources 140 include multiple clusters 210 mapped to one or more storage elements 220. In the illustrated embodiment, each cluster 210 has access to all storage elements 220. In some embodiments, clusters 210 may have access to only one or a portion of the storage elements 220 within available execution resources 140.

For example, in some embodiments, cluster 210A is mapped to storage 220A, cluster 210B is mapped to storage 220B, and cluster 210N is mapped to storage 220M. In some embodiments, if cluster 210A is only mapped to storage 220A, cluster 210A only has access to storage 220A.

In some embodiments, clusters 210 include multiple processors and/or network interface elements. In some embodiments, a cluster 210 may include multiple computers or computing nodes. In other embodiments, a cluster 210 may include only a portion of a given computing system or processor.

FIG. 2 provides one example of organizing execution resources using clusters, but this example is provided for purposes of explanation and is not intended to limit the scope of the present disclosure. In other embodiments, any of various appropriate organization or granularities of assignment of execution resources may be implemented on conjunction with disclosed techniques.

### Overview of Queue Map Implementation

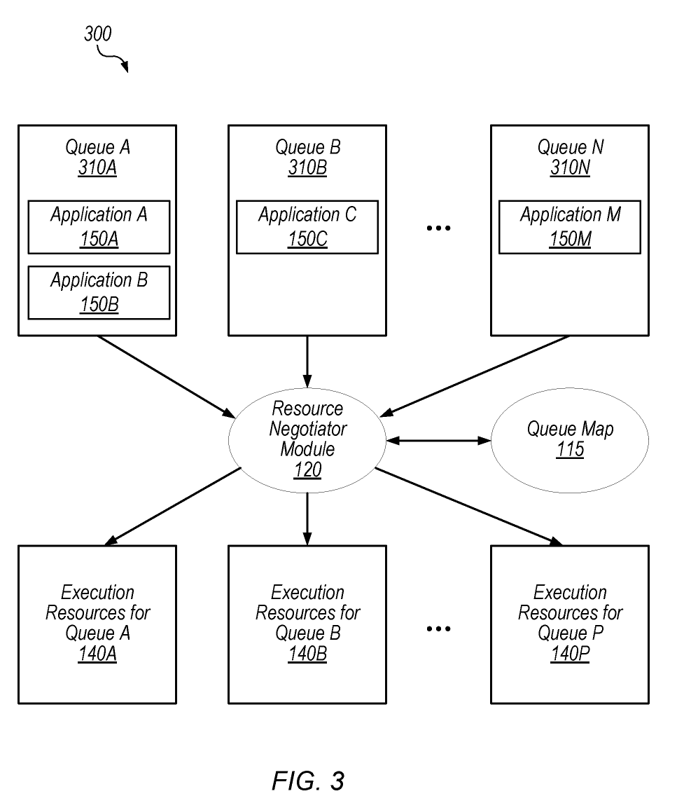

FIG. 3 is a diagram illustrating exemplary use of a queue map to manage assignment of different execution resources to different queues, according to some embodiments. In the illustrated embodiment, system 300 includes resource negotiator module 120 that maintains queue map 115, queues 310A-310N (which in turn may store ones of applications 150A-150M), and execution resources 140A-140N. In some embodiments, resource negotiator module 120 is configured to assign respective execution resources 140 to respective ones of the queues 310 based on queue map 115.

In the illustrated embodiment, resource negotiator module 120 does not store the queue map 115 internally. Thus, in some embodiments, the queue map 115 is stored at another location and is accessed by the resource negotiator module 120.

In the illustrated embodiment, queue 310A handles applications 150A and 150B, queue 310B handles application 150C and queue 150N handles application 150M. Note that queues may be empty when all of their applications have completed execution, e.g., until arrival of another application for that queue. In the illustrated embodiment, resource negotiator module 120 is configured to dispatch ones of the applications 150 from queues 310 for execution using the corresponding queue's execution resource. In the illustrated embodiment, the resource negotiator module 120 is configured to dynamically determine the amount of execution resources assigned to each queue based on queue map 115, which may impact the time that applications in different queues wait before they are dispatched and/or how quickly they execute once they are dispatched.

In some embodiments, one or more applications 150 have priority within a queue 310. For example, application 150A may have priority over application 150B. In some embodiments, resource negotiator module 120 will assign an amount of execution resources to one or more queues 310 based on the priority of one or more applications 150 assigned to one or more queues 310. For example, resource negotiator module 120 may adjust queue map 115 to increase the amount of execution resources 140A in response to queue 310A having (or frequently having over time) a high-priority application.

In some embodiments, applications 150 may be sent directly to the resource negotiator module 120, e.g., where the resource negotiator module maintains queues 310 internally. In other embodiments, applications 150 may be sent to queues 310 that are maintained externally from the resource negotiator module 120.

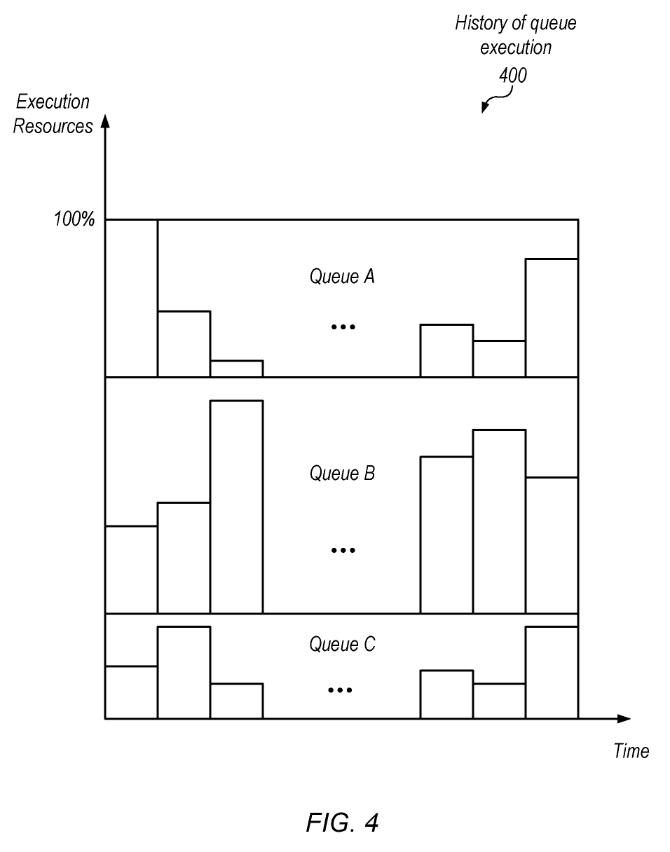

FIG. 4 is a plot of an exemplary history of queue execution with a static amount of execution resources assigned to one or more queues, according to some embodiments. In the illustrated embodiment, resource negotiator module 120 manages queues A, B, and C, which are each assigned fixed amounts of execution resources over time.

In In the illustrated example, queue A uses all of its assigned execution resources during an initial interval and then uses varying amounts of resources subsequently. Thus, at certain points in time, queue A only uses a portion of the assigned execution resources 140. Queues B and C behave similarly, in some embodiments. In the illustrated embodiment, inefficiencies can be seen at various times due to unused execution resources 140. For example, one queue may have available execution resources (e.g., queue B or C at the beginning of the illustrated plot) while another queue is using all of its assigned execution resources (e.g., queue A at the beginning of the illustrated plot). Therefore, in some embodiments, queue map 115 is configured to specify varying amounts of execution resources assigned to different queues at different times, e.g., based on past history of queue management.

FIG. 5 is a plot illustrating information indicated by an exemplary queue map, according to some embodiments. In the illustrated embodiment, queue map 115 specifies amounts of execution resources for queues A, B, and C during time intervals 1, 2, 3,4, etc.

In some embodiments, when generating a queue map, resource negotiator module 120 is configured to determine amounts of execution resources allocated to queues based on the start times of applications in the queue, how quickly the queues need to be completed, how long applications in queues waited during past execution with fixed amounts of hardware resources, etc. In the illustrated embodiment, queue map 115 specifies that 100% of the execution resources are assigned to queues A, B, and Cover the entire time period. In other embodiments, a portion of available execution resources may be unassigned, e.g., when resource negotiator module 120 determines that additional execution resources would not increase performance during a particular interval.

In the illustrated embodiment, the amount of execution resources is adjusted over the time period for queues A, B, and C, which may enable the efficient use of execution resources. In the illustrated embodiment, during interval 1 queue A is using approximately 60% of the execution resources available and queues B and C are using approximately 20% each. In the illustrated embodiment, for interval 2, queue A is using approximately 40%, queue B is using approximately 45%, and queue C is using approximately 15% of the execution resources. For interval 3, in the illustrated embodiment, queue A continues to use approximately 40% of the execution resources, while queue B only uses approximately 35% and queue C uses approximately 25%. For interval 4, in the illustrated embodiment, queue A continues to use approximately 40% of the execution resources, while queue B only uses approximately 30% and queue C uses approximately 30%. In some embodiments, resource negotiator module 120 may not assign a given queue any execution resources during a particular time interval.

In some embodiments, priority information is maintained for one or more queues. For example, one queue may have priority over another queue. Any of various levels of priority may be maintained. In some embodiments, queue priority is based on how many applications are within the queue, how long each application will take to execute, and/or the priority of one or more applications in the queue. For example, in the illustrated embodiment, queue A has higher priority than queue B during interval 1. Therefore, in the illustrated embodiment, queue A is assigned at least twice as many execution resources 140 as queue B. In the illustrated embodiment, the resource negotiator module 120 receives priority information for one or more applications. For example, consider an example situation where queue B only receives one application while queue A receives 100 applications during interval 1. Further, in this example, according to the priority information received by the resource negotiator module, queue B has higher priority than queue A. Therefore, the resource negotiator module assigns approximately 20% of the execution resources to queue B and approximately 60% to queue A, even though queue B may have significantly less processing needs than queue A. Therefore, in some embodiments, resource negotiator module 120 uses the priority information of the applications to determine the amounts of execution resources to assign to each queue.

In some embodiments, priority information is maintained for one or more applications in a queue. In some embodiments, the priority of an application is based on one or more characteristics of the application. For example, in the illustrated embodiment, one application within a queue A has priority over another application. As a result, in the illustrated embodiment, queue A may execute the application with higher priority first. In addition, in the illustrated embodiment, the application with higher priority may be allowed to use more of the execution resources assigned to Queue A than the application with lower priority, e.g., if queue A has enough resources for both applications to be executed at least partially in parallel.

### Queue Map Prediction Example

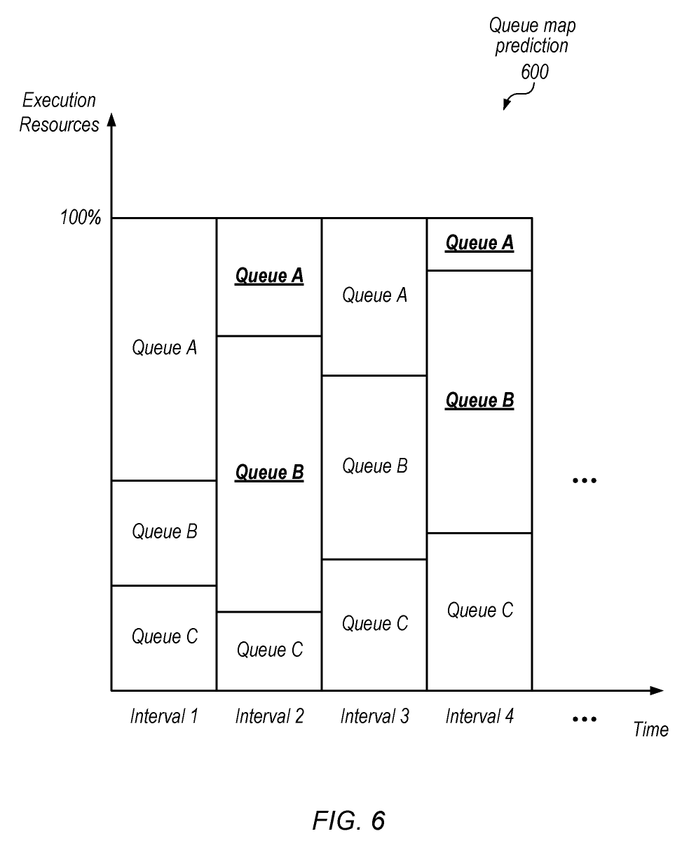

FIG. 6 is a plot illustrating an exemplary queue map prediction, according to some embodiments. In the illustrated embodiment, queue map prediction 600 shows predicted modifications to the queue map of FIG. 5 based on the addition of one or more applications to one or more particular queues. In particular, differences in amounts of execution resources assigned to queues A and B during intervals 2 and 4, relative to FIG. 5 are underlined and shown in bold. In some embodiments, resource negotiator module 120 is configured to generate information specifying the queue map prediction before actually implementing an updated queue map. This may allow a user or program submitting the one or more applications to determine whether it wants to proceed with the proposed addition of applications, based on the predicted results.

In the illustrated embodiment, the resource negotiator module 120 simulates a predicted modification to the queue map based on receiving one or more applications for execution. In the illustrated embodiment, resource negotiator module predicts that it would assign more resource to queue B during intervals 2 and 4 if the proposed applications were added. In the illustrated embodiment, the predicted modifications would take execution resources 140 from queue A and allocate them to queue B during these intervals.

In some embodiments, the predicted modification from the resource negotiator module 120 is for one specific interval (e.g. 1, 2, 3, etc.) within the queue map 115 rather than for a given period of time. In some embodiments, one or more applications received by the resource negotiator module 120 include instructions to execute the applications during a particular interval or a prediction of a time at which the applications will arrive at the proposed queue.

In some embodiments, the resource negotiator module 120 generates queue map 115 based on queue map history (e.g., as discussed above with reference to FIG. 5), In some embodiments, queue map history includes the following: when application(s) are submitted for execution, the amount of execution resources 140 assigned to queue(s), the portion of a queue's execution resources 140 being used at a given time, and the length of time used by a queue to complete one or more applications. Resource negotiator module 120 may consider similar information when determining whether to update queue map 115 and/or when predicting updates to queue map 115 based on a proposed application.

In some embodiments, resource negotiator module 120 is configured to dynamically update the queue map based on current execution conditions (e.g., requirements by applications in one or more queues). In some embodiments, one application is submitted to queue A. In some embodiments, this application includes instructions to complete execution by a specific time. In some embodiments, queue B may have a greater amount of applications to execute than queue A. However, in some embodiments, the resource negotiator module 120 assigns a greater amount of execution resources 140 to queue A than to queue B, to allow for queue A to complete execution of the application according to the specified time. In some embodiments, the resource negotiator module 120 may dynamically update the queue map even when all execution resources are currently being used.

In some embodiments, the resource negotiator module 120 generates multiple queue map predictions. For example, in some embodiments, the multiple queue map predictions are based on simulated assignment of application(s) to different queues for each prediction and predicted outcomes. In some embodiments, the multiple queue map predictions are then presented for approval or rejection. In some embodiments, one of the multiple queue map predictions is selected or approved. In some embodiments, this approved queue map prediction is implemented by the resource negotiator module 120. In some embodiments, the queue map prediction is implemented immediately when approved (e.g., in contrast to being updated based on a history the added applications being executed once they are added). This may improve performance of the added applications, even the first time they are executed, by allocating proper execution resources based on the prediction.

In some embodiments, the selection of a particular queue map prediction for execution is automatically done by a module (for example, the resource negotiator module 120 or a module in communication with resource negotiator module 120) based on the percentage of resources being used by each queue, application wait time, etc. of various predictions.

### Example Method

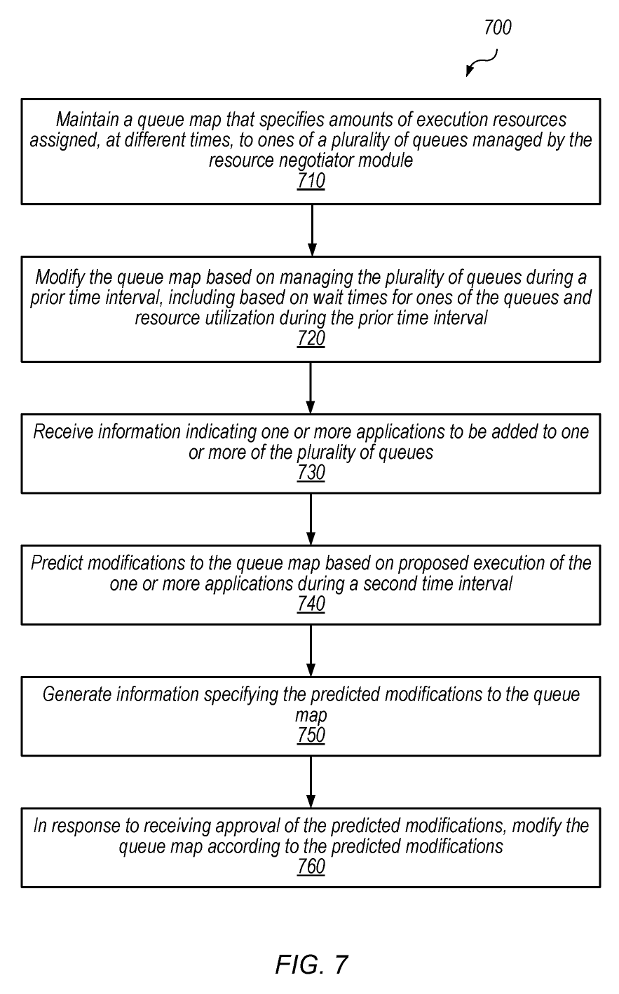

FIG. 7 is a flow diagram illustrating an exemplary method for queue map prediction, according to some embodiments. The method shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 710, in the illustrated embodiment, a resource negotiator module (e.g., module 120) maintains a queue map that specifies amounts of execution resources assigned, at different times, to ones of a plurality of queues managed by the resource negotiator module.

At 720, in the illustrated embodiment, the resource negotiator module modifies the queue map based on managing the plurality of queues during a prior time interval, including based on wait times for ones of the queues and resource utilization during the prior time interval.

At 730, in the illustrated embodiment, the resource negotiator module receives information indicating one or more applications to be added to one or more of the plurality of queues.

At 740, in the illustrated embodiment, the resource negotiator module predicts modifications to the queue map based on proposed execution of the one or more applications during a second time interval.

At 750, in the illustrated embodiment, resource negotiator module generates information specifying the predicted modifications to the queue map.

At 760, in the illustrated embodiment, in response to receiving approval of the predicted modifications, the resource negotiator module modifies the queue map according to the predicted modifications.

In some embodiments, the resource negotiator module generates a queue map based on previous execution of one or more applications corresponding to ones of the plurality of queues over one or more time periods with fixed respective amounts of execution resources for the plurality of queues.

In some embodiments, the resource negotiator module maintains information that indicates priority levels for one or more queues. In some embodiments, priority levels of at least one of the plurality of queues is based on one or more applications. In some embodiments, the resource negotiator module generates, adjusts, and/or predicts the queue map based in part on priority levels of queues and/or applications.

In some embodiments, the resource negotiator module causes information specifying predicted modifications to be displayed.

In some embodiments, the resource negotiator module performs multiple simulations of adding ones of the one or more applications to multiple different ones of the plurality of queues. In some embodiments, the resource negotiator module generates information specifying multiple sets of simulated changes based on addition of one or more applications to different ones of the plurality of queues.

The term “proposed” is intended to be construed according to its well understood meaning, which includes indicating that an action may be performed (e.g., adding an application to a queue) but that it has not been performed yet. Therefore, predictions may be generated for a proposed action without the action actually being performed. In various embodiments, information about proposed applications may specify when they are estimated to run, predicted amounts of execution resources needed, etc.

### Example Computing Device

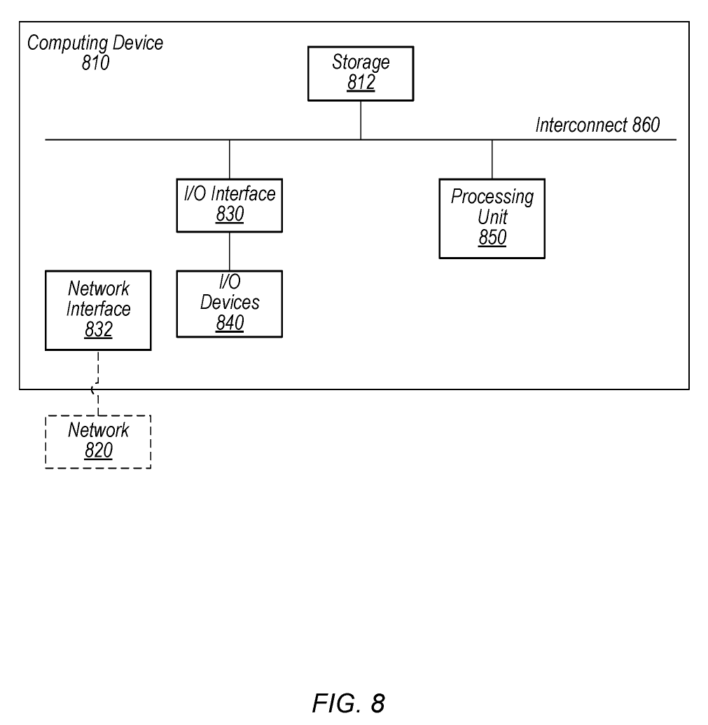

Turning now to FIG. 8, a block diagram of one embodiment of computing device (which may also be referred to as a computing system) 810 is depicted. Computing device 810 may be used to implement various portions of this disclosure. Computing device 810 may be any suitable type of device, including, but not limited to, a personal computer system, desktop computer, laptop or notebook computer, mainframe computer system, web server, workstation, or network computer. As shown, computing device 810 includes processing unit 850, storage 812, input/output (I/O) interface 830 coupled via an interconnect 860 (e.g., a system bus). I/O interface 830 may be coupled to one or more I/O devices 840. Computing device 810 further includes network interface 832, which may be coupled to network 820 for communications with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 812 is usable by processing unit 850 (e.g., to store instructions executable by and data used by processing unit 850). Storage subsystem 812 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 812 may consist solely of volatile memory in one embodiment. Storage subsystem 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. These articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

What is claimed is:

1. An apparatus, comprising:
one or more processors; and
one or more memories having program instructions stored thereon that are executable by the one or more processors to:
maintain, by a resource negotiator module, a queue map that specifies, for execution resources of one or more server systems, amounts of execution resources assigned, at different times, to ones of a plurality of queues managed by the resource negotiator module;
modify the queue map based on attributes of the plurality of queues during a prior time interval, including based on wait times for ones of the queues and execution resource utilization during the prior time interval;
receive information indicating one or more applications to be added to one or more of the plurality of queues;
predict modifications to the queue map by the apparatus based on proposed execution of the one or more applications during a second time interval;
generate information specifying the predicted modifications to the queue map;
receive approval of the predicted modifications; and
modify the queue map according to the predicted modifications in response to the approval.

2. The apparatus of claim 1, wherein the resource negotiator module is adapted to generate the queue map based on previous execution of one or more applications corresponding to ones of the plurality of queues over one or more time periods with fixed respective amounts of execution resources for the plurality of queues.

3. The apparatus of claim 1, wherein the resource negotiator module is adapted to maintain information indicating priority levels for ones of the plurality of queues and modify the queue map based on the priority levels.

4. The apparatus of claim 3, wherein the priority level for at least one of the plurality of queues is based on characteristics of the one or more applications in the queue.

5. The apparatus of claim 1, wherein the instructions are further executable to:
cause the information specifying the predicted modifications to be displayed and receive input accepting or rejecting the addition of the one or more applications to the one or more of the plurality of queues.

6. The apparatus of claim 1, wherein, to predict modifications to the queue map, the resource negotiator module is adapted to:
generate predictions of modifying the queue map based on adding ones of the one or more applications to multiple different ones of the plurality of queues and wherein the generated information specifies multiple sets of predicted modifications to the queue map based on addition of the ones of the one or more applications to different ones of the plurality of queues.

7. The apparatus of claim 6, wherein the resource negotiator module is further adapted to: select one of the sets of modifications based on one or more criteria.

8. The apparatus of claim 1, wherein the resource negotiator is a node manager agent that assigns amounts of execution resources in ones of a plurality of nodes of the one or more server systems.

9. A method, comprising:
maintaining, by a resource negotiator module of a computing system, a queue map that specifies amounts of execution resources of one or more server systems assigned, at different times, to ones of a plurality of queues managed by the resource negotiator module;
modifying, by the computing system, the queue map based on managing the plurality of queues during a prior time interval, including based on wait times for ones of the queues and resource utilization during the prior time interval;
receiving, by the computing system, information indicating one or more applications to be added to one or more of the plurality of queues;
predicting, by the computing system, modifications to the queue map based on proposed execution of the one or more applications during a second time interval;
generating, by the computing system, information specifying the predicted modifications to the queue map;
receiving, by the computing system, approval of the predicted modifications; and
modifying, by the computing system, the queue map according to the predicted modifications in response to the approval.

10. The method of claim 9, further comprising:
generating, by the computing system, the queue map based on previous execution of one or more applications corresponding to ones of the plurality of queues over one or more time periods with fixed respective amounts of execution resources for the plurality of queues.

11. The method of claim 9, further comprising:
maintaining, by the resource negotiator module, information indicating priority levels for ones of the plurality of queues.

12. The method of claim 11, wherein the information indicating priority levels of at least one of the plurality of queues is based on characteristics of the one or more applications in the queue.

13. The method of claim 9, further comprising:
causing information specifying the predicted modifications to be displayed and receiving input accepting or rejecting the addition of the one or more applications to the one or more of the plurality of queues.

14. The method of claim 13, further comprising:
modifying the queue map, according to the predicted modifications by the resource negotiator module, in response to approval of the addition.

15. The method of claim 9, wherein the predicting includes predicting modifications to the queue map based on adding ones of the one or more applications to multiple different ones of the plurality of queues and wherein the generated information specifies multiple sets of predicted modifications based on addition of the ones of the one or more applications to different ones of the plurality of queues;
the method further comprising: selecting one of the sets of modifications based on one or more criteria.

16. A non-transitory, computer-readable medium having instructions stored thereon that are executable by a computer system to perform operations comprising:
maintaining, by a resource negotiator module of a computing system, a queue map that specifies amounts of execution resources of one or more server systems assigned, at different times, to ones of a plurality of queues managed by the resource negotiator module;
modifying the queue map based on managing the plurality of queues during a prior time interval, including based on wait times for ones of the queues and resource utilization during the prior time interval;
receiving information indicating one or more applications to be added to one or more of the plurality of queues;
predicting modifications to the queue map by the computer system based on proposed execution of the one or more applications during a second time interval;
generating information specifying the predicted modifications to the queue map;
receiving approval of the predicted modifications; and
modifying the queue map according to the predicted modifications in response to the approval.

17. The non-transitory, computer-readable medium of claim 16, wherein the operations further comprise:
generating, by the computing system, the queue map based on previous execution of one or more applications corresponding to ones of the plurality of queues over one or more time periods with fixed respective amounts of execution resources for the plurality of queues.

18. The non-transitory, computer-readable medium of claim 16, wherein the operations further comprise:
causing information specifying the predicted modifications to be displayed and receiving input accepting or rejecting the addition of the one or more applications to the one or more of the plurality of queues.

19. The non-transitory, computer-readable medium of claim 16, wherein predicting modifications includes predicting modifications to the queue map based on adding ones of the one or more applications to multiple different ones of the plurality of queues and wherein the generated information specifies multiple sets of predicted modifications based on addition of the ones of the one or more applications to different ones of the plurality of queues.

20. The non-transitory, computer-readable medium of claim 19, wherein the operations further comprise:
selecting one of the sets of modifications based on one or more criteria.
